(19) United States
(12) Patent Application Publication
(10) Pub. No.: US 2009/0210344 A1
(43) Pub. Date: Aug. 20, 2009

(54) SYSTEM AND METHOD FOR PROVIDING DATA FOR USE IN REDUCING FRAUDULENT TRANSACTIONS BETWEEN HOLDERS OF FINANCIAL PRESENTATION DEVICES AND MERCHANTS

(76) Inventors: Jeffrey Kevin Lange, San Ramon, CA (US); Krishna P. Koganti, Cupertino, CA (US); Jay Allen Dewitt, Spokane, WA (US); Patrick Lee Faith, Pleasanton, CA (US)

Correspondence Address: AFS/ VISA, 666 THIRD AVENUE , 10TH FLOOR, NEW YORK, NY, 10017, US

(21) Appl. No.: 12/031,965

(22) Filed: Feb. 15, 2008

(51) Int. Cl. G06Q 20/00

(52) U.S. Cl. 705/44; 705/35

(57) ABSTRACT

System and method for providing an address verification response associated with a financial presentation device being used to conduct a transaction with a merchant. The system includes a memory storing addresses of holders of financial presentation devices and a date corresponding to a last change of address associated with each financial presentation device, and an address verification program which is operable to receive a request from the merchant to verify an address associated with the financial presentation device; determine a temporal indicator identifying a time period since a holder of the financial presentation device last changed the address; and provide the determined temporal indicator with the address verification response to the merchant.

### FIELD OF THE INVENTION

The present invention relates to fraud prevention for financial presentation devices, such as credit cards and more specifically, to a system and method for providing data for use in reducing fraudulent transactions between holders of financial presentation devices and merchants.

### BACKGROUND OF THE INVENTION

Today, most people carry portable financial presentation devices such as credit cards, debit cards, prepaid cards, stored value devices and smart tag devices to pay for goods and services without using cash. All of these financial presentation devices have an account number by which an individual device is uniquely identified. In the case of a credit or debit card, the account number typically has a 16 digit card identifier (i.e., number) and expiration date embossed on the card. The 16 digit number consists of an initial 6 digit Bank Identification Number (BIN), followed by a 10 digit number. The BIN identifies the issuer financial institution (e.g., bank), such as Bank of America®, Chase®, among others that issue credit cards. The remaining 10 digit number identifies a particular card issued by the issuer. Accordingly, the 16 digit number on the credit or debit card uniquely identifies a card, and therefore the cardholder. Once the portable financial presentation device expires, it can no longer be used by the end-user to purchase goods and/or services from providers (i.e., merchants) of such goods and/or services.

Present security techniques include card security codes (CSC), which include a first code, called card verification code (CVC1) or card verification value (CVV1), encoded on the magnetic stripe of the card and used for transactions in person.

Many merchants of goods and/or services allow customers to use their financial presentation device to conduct a transaction without the presentation device being physically available for processing the transaction by the merchant. These types of transactions are generally known as “card-not-present” (CNP) transactions, which are expedient techniques employed by merchants to increase sales volume and provide convenient transactional service for their customers. Transactions that are key-entered typically occur when the card's magnetic stripe cannot be read by the card reading terminal of the merchant. Accordingly, card-not-present or key entered transactions typically occur in instances where the merchant, retailer or other service provider does not have physical access to the payment card. Examples of CNP transactions typically include transactions that are conducted by telephone, mail order or at the website of the merchant (i.e., over the Internet) between a cardholder and a merchant.

A second security code (known as Credit Card Identification (CCID)) is often asked for by merchants so that they can secure “card not present” transactions occurring over the Internet, by mail, fax or over the phone. This card security code (also known as CVV2 or CVC2) is not embossed on the front panel of the financial presentation device like the card identifier number, and is always the final group of numbers printed on the back signature panel of the card. Due to increased attempts at card fraud, many merchants mandate that the second code be provided when the cardholder is not present in person during the transaction.

To help merchants mitigate fraud in the challenging card-not-present (CNP) environment, Address Verification Services (AVS) have been implemented at the financial transaction processing facilitators, such as VISA®. Merchants utilize this optional CNP fraud mitigation service by sending the cardholder's billing address including zip code to the processing facilitator and receiving an AVS result code in the response. For example, one AVS result code may be a “no match” in which both the street address and the zip code do not match. In that case, it is more likely that the transaction is a fraudulent transaction. Armed with the information, the merchant may decline the transaction.

Despite following the processing facilitators' CNP best practices, leading CNP merchants have reported an increase in fraud for transactions with AVS matches (e.g., address and zip code match with what is on the issuer's file).

Therefore, it is desirable to provide a system and method for enabling a financial institution, such as an issuer or processing facilitator to provide additional data to reduce fraudulent transactions, especially for merchants accepting card-not-present transactions.

### SUMMARY OF THE INVENTION

According to one aspect of the present invention, a method is provided for providing data for use in reducing fraudulent transactions between a holder of a financial presentation device and a merchant. The method includes receiving an address verification request to verify an address associated with the financial presentation device; determining a temporal indicator identifying a time period since the holder of the financial presentation device last changed the address; and providing the determined temporal indicator to the merchant.

The address can be a billing statement address of record of the cardholder. Additionally, an indication of whether the received billing address matches the billing address of the holder of the financial transaction device can be sent to the merchant.

In an embodiment of the present invention, the step of determining a temporal indicator includes retrieving a date associated with the last address change, and calculating the time period from a current date of the request to the retrieved date associated with the last address change. Further, the time period since the holder of the financial presentation device last changed the address can be divided into a plurality of time ranges, such that the step of determining a temporal indicator includes determining which one of the plurality of time ranges the calculated time period belongs, and the step of providing the determined temporal indicator includes sending the determined time range to the merchant.

In one embodiment, the method provides a temporal indicator representing a number of days that a most recent change of address has occurred. Alternatively, the method can provide a temporal indicator representing one or more alpha-numeric characters representing a range of time periods or no information is available. For example, in one embodiment, the step of providing one or more alpha-numeric characters includes providing at least one first alpha-numeric character representing no information available, at least one second alpha-numeric character representing less than five days, at least one third alpha-numeric character representing 5 to 30 days, at least one fourth alpha-numeric character representing 30 to 60 days, at least one fifth alpha-numeric character representing 61 to 90 days, at least one sixth alpha-numeric character representing 91 to 120 days, at least one seventh alpha-numeric character representing 121 to 180 days, at least one eighth alpha-numeric character representing 181 to 365 days, and at least one ninth alpha-numeric character representing greater than 365 days.

In one embodiment, the step of receiving a request from a merchant includes receiving a request originating from a card-not-present transaction. Alternatively, the step of receiving a request from a merchant can include receiving a request originating from a card-present transaction.

Where the address verification request is being performed by the merchant during a transaction, in one embodiment, the step of receiving a request from the merchant can also include receiving a request to authorize the transaction. Further, the step of providing the determined temporal indicator can include providing the temporal indicator in a predetermined field of a response to the authorization message. In one embodiment, the step of providing the determined temporal indicator includes providing the address verification response in real time.

According to another aspect of the present invention, a system for providing an address verification response associated with a financial presentation device being used to conduct a transaction with a merchant is provided. The present invention is highly suitable for card-not-present transactions, as well as card-present transactions.

The system includes a memory storing addresses of holders of financial presentation devices and a date corresponding to a last change of address associated with each financial presentation device; a processor coupled to the memory; and an address verification program stored in the memory and executable by the processor. The address verification program is operable to receive a request from the merchant to verify an address associated with the financial presentation device; determine a temporal indicator identifying a time period since a holder of the financial presentation device last changed the address; and provide the determined temporal indicator with the address verification response to the merchant.

Alternatively, the address verification request is included with a transaction authorization request from the merchant, and the temporal indicator is provided with a transaction authorization response. In this alternative embodiment, the address verification program is operable to provide the temporal indicator in a predetermined field of a response to the transaction authorization message.

In one embodiment, the address is a billing address associated with the financial presentation device. Further, the address verification program is further operable to send the merchant an indication of whether the received billing address matches the billing address of the holder of the financial transaction device. The address verification program is further operable to send the merchant an indication of whether the received billing address matches the billing address of the holder of the financial transaction device.

In one embodiment, the address verification program is operable to retrieve a date associated with the last address change; and calculate the time period from a current date of the request to the retrieved date associated with the last address change. Alternatively, the time period since the holder of the financial presentation device last changed the address can be divided into a plurality of time ranges, and the address verification program is operable to determine which one of the plurality of time ranges the calculated time period belongs; and send the determined time range to the merchant.

In one embodiment, the temporal indicator can include a number of days that a most recent change of address has occurred. In another embodiment, the temporal indicator can be one or more alpha-numeric characters representing a range of time periods since the holder of the financial presentation device last changed the address or that no information is available.

### BRIEF DESCRIPTION OF THE DRAWINGS

FIG. 1 is a block diagram of an exemplary system for processing transactions for goods and/or services between a customer and merchant using mobile financial presentation devices;

FIG. 2 illustrates a block diagram of a computer device suitable for providing authorization and verification of transactions occurring in the system of FIG. 1;

FIG. 3 is a flow diagram of a first embodiment of a method for providing an address verification response to a merchant conducting a transaction with a cardholder in accordance with the present invention; and

FIG. 4 is a flow diagram of another embodiment of a method for providing an address verification response to a merchant conducting a transaction with a cardholder in accordance with the present invention.

### DETAILED DESCRIPTION OF THE INVENTION

For purposes of illustration and clarity, the present invention will be discussed in the context of using a financial presentation device such as a credit card. However, persons of ordinary skill in the art will appreciate that the novel features disclosed herein apply to all types of portable financial presentation devices including, but not limited to, credit cards, debit cards, prepaid cards, electronic benefit cards, charge cards, smart cards, key chain devices, personal digital assistants, cell phones, stored value devices or the like, so long as the device can be presented to a seller of goods or services for payment.

Applicant of the present invention has extensively studied the fraudulent transactions that occur despite following the best practices advised by the processing facilitator. Based on the study, it was concluded that account takeover is likely occurring in many of the fraudulent transactions. Account takeover fraud occurs when a non authorized person or entity obtains enough personal information about an individual to effectively represent the rightful person with his card issuing bank. For example, it has been observed that many fraudulent entities call the card issuers and change the billing address of record knowing that the merchants check the billing address provided at the time of a transaction with the billing address of record at the card issuer.

As persons of ordinary skill in the art will appreciate, the merchants are often placed in an undesirable circumstance of authorizing the card-not-present transactions to fraudulent entities, which can lead to losses in revenues. Further, this can result in merchant dissatisfaction with the overall system because the authorization process becomes cumbersome, added expenses are required to obtain verification information at each point of sale (POS) to authenticate the party that is actually making the CNP transactions, as well as reduce sales and revenues, and cause declines in their customer base.

Further, the inability of a merchant to receive valid account verification information can increase the costs associated with contacting customers to obtain the updated information, as well as possibly cause interrupted service from the perspective of the consumer.

The present invention helps to reduce fraudulent transactions, such as those occurring by dishonest persons who commit account takeover of the holder of the financial presentation device. As described and illustrated by the drawings below, the present invention includes a system and method for receiving an address verification request having an address associated with the financial presentation device; determining a temporal indicator identifying a time period since the holder of the financial presentation device last changed the address; and providing the determined temporal indicator to the merchant.

More specifically, according to the present invention, address verification and/or authorization messages, which are used for approving sales transactions between holders of financial presentation devices and merchants of goods and services, include an indicator representing a time period since the holder last changed an address. Preferably, the time period indicator represents the number of days since the cardholder last changed an address of record with the issuer. Although the present invention is described as a change in the billing statement address of the cardholder, such address change is not considered limiting. For example, the time period indicator can also represent number of days since the cardholder last changed a shipping or residential address.

In one embodiment, a numeric (or alphabetic) character is used to represent a range of dates, such as “0” representing no information available; “1” representing less than five (5) days; “2” representing six (6) to thirty (30) days; “3” representing thirty-one (31) to sixty (60) days; and so forth. As described below, a person skilled in the art will appreciate that other indicators can be implemented to represent time intervals (i.e., days, weeks, months, years) since the cardholder last changed their billing statement address.

Merchants, and more specifically, card-not-present (CNP) merchants, can employ this novel address verification service data to make a more informed transaction decision, such as approving, declining, and investigating the transaction. For example, if a CNP merchant receives an authorization message from the issuer institution that indicates that the CNP cardholder has changed his/her billing address in less than five days, the CNP merchant can choose to request additional information from (i.e., investigate) the cardholder, and based on the investigation results, either accept or decline the present transaction.

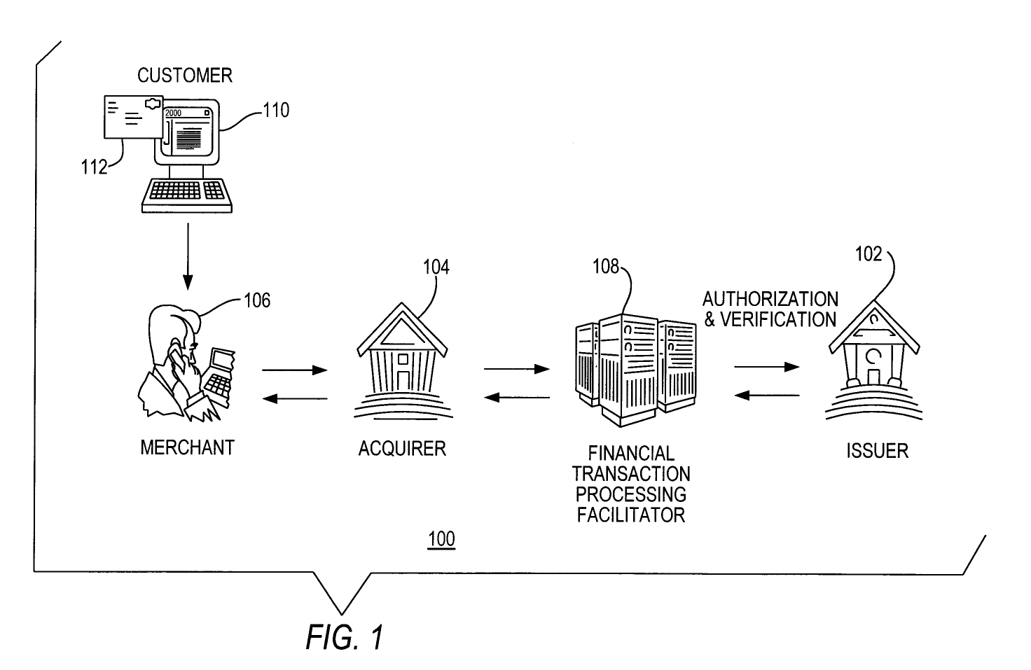

Referring now to FIG. 1, an exemplary block diagram of the above-described financial presentation device transaction system 100 is shown. The financial presentation device transaction system 100 includes at least one issuer bank 102, at least one acquirer bank 104, at least one merchant 106, and an processing facilitator 108. Each issuer 102 is a financial institution (e.g., bank) or other organization that issues the mobile financial presentation devices (e.g., credit/debit card) 112 to the cardholders 110. The recipient cardholders 110 are the bonafide owners of the cards 112, which can be used in transactions to purchase goods and services from merchants 106. Each merchant 106 is a business that sells goods and/or services and that accepts a financial presentation device 110 for conducting a sales transaction for products/services being sold by the merchant 106 to the cardholder 110. Each acquirer 104 is a financial institution (e.g., bank) or other organization that provides card processing services to the merchant 106.

For purposes of understanding the invention, the processing facilitator 108 is defined as an entity such as VISA® or MASTERCARD® (and others), that operates a network which serves as an intermediary between the acquirer 104 and issuer 106 for facilitating authorization, funding and processing of transactions. More specifically, the processing facilitator 108 is an entity that manages the processing, clearing and settlement of financial presentation device (e.g., credit/debit card) transactions, including the assessment, and collection and/or distribution of fees between parties.

From the perspective of the merchants 106, a credit/debit card transaction is often more secure than other forms of payment, such as checks, because the issuing bank commits to pay the merchant the moment the transaction is authorized, regardless of whether the consumer defaults on their credit card payment, excluding legitimate disputes, which can result in charge backs to the merchant. For each purchase, the bank charges a commission (discount fee) to the merchant for this service.

When the cardholder 110 pays for the purchase the merchant 106 performs some risk assessment and may submit the transaction to the acquirer 104 for authorization. The acquirer 104 verifies with the issuer 102, almost instantly, that the card number (with expiration date) and transaction amount are both valid, and informs the merchant 106 on how to proceed. The issuer 102 may provisionally debit the funds from the cardholder's credit account at this stage.

A sales transaction between a cardholder 110 and a merchant 106 can be made with the card present at the merchant's physical location for inspection and processing, for example, through a magnetic strip card reading terminal or by key entry. The cardholder 110 indicates his/her consent to pay, by signing a receipt with a record of the card details and indicating the amount to be paid or by entering a personal identification number (PIN). When a cardholder 110 purchases an item, the cardholder 110 agrees to pay the card issuer 102, which in turn pays the merchant 106 via the acquirer 104. Transfer of payments and charge-backs between the issuer 102 and acquirer 104 are facilitated by the processing facilitator 108.

Alternatively, many merchants 106 authorize transaction via telephone, mail through the Internet. These types of transactions in which the financial presentation device 112 is not physically present for the merchants to directly process are known as card-not-present (CNP) transactions.

Referring to FIG. 1, an electronic verification system allows a merchant 106 to verify that the card 112 is valid and that the cardholder 110 has sufficient credit/funds to cover the purchase in a few seconds, allowing the verification to occur at time of purchase. The verification is performed using a card payment terminal or Point of Sale (POS) system with a communications link to the merchant's acquiring bank 104. Data from the card 112 is obtained from a magnetic stripe or chip on the card in a well known manner. In one embodiment, the data from the card is transmitted to the acquirer 104 which forwards the verification information to the issuer 102 via the processing facilitator 108. Alternatively, the data from the card is transmitted to the processing facilitator 108, which forwards the verification information to the issuer 102.

The issuer 102 performs verification and authorization of the card information received for each transaction from the merchants 106. The issuer will send either an authorization message that either accepts or declines the transaction back to the merchant 106 via the reverse path through the processing facilitator 108, acquirer 104 and merchant 106.

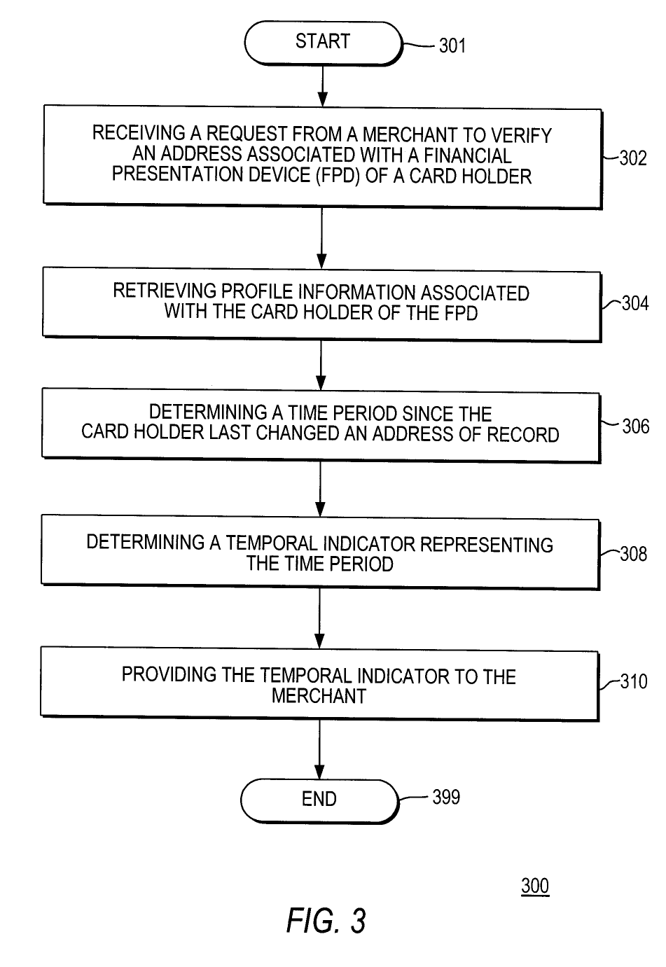

As described below in further detail with respect to the flow diagram of FIG. 3, the verification process for merchants 106 providing card-not-present transactions with their prospective customers 110 includes receiving the most current billing statement address from the cardholder and an indicator representing a time period since such billing statement address was last changed from the issuer. The merchant 106 can use the time period indicator as a determinant to proceed with the sales transaction, such as by accepting or declining the transaction for the goods/services with cardholder 110 of the CNP financial presentation device 112.

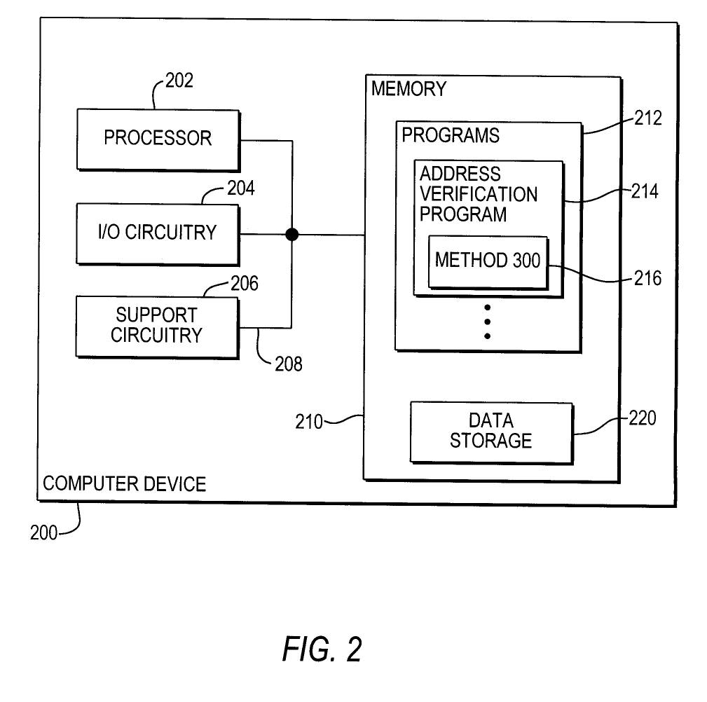

Referring now to FIG. 2, at least one computer device 200 provides authorization and verification for financial presentation device transactions between customers 110 and merchants 106. The computer device 200 is preferably one or more servers, a mainframe or combination thereof, although other computer devices can be utilized, such as a personal computer, minicomputer, and workstation among others. While the server 200 is shown, for illustration purposes, as a single computer unit, the system may comprise a group/farm of computers which can be scaled depending on the processing load and database size. The computer device 200 includes a multitasking, real-time software technology that can concurrently handle hundreds of thousands of queries and updates.

The computer device 200 is preferably facilitated and operated by the issuing institution 102. However, the computer device can be facilitated and operated by other third party entities, such as the processing facilitator 108, an acquirer 104 or other third party entities. For example, a processing facilitator 108 can implement the system and method of the present invention and in one embodiment, retrieve change-of-address information from the database(s) of another third party entity, such as the US Postal Service, among others. Accordingly, the computer device 200 shown in FIG. 2 is generally suitable for use at any location or entity within the system 100.

The computer device 200 comprises at least one processor 202, as well as memory 210 for storing various control programs 212. The processor 202 may be any conventional processor, such as one or more INTEL® processors. The memory 210 can comprise volatile memory (e.g., DRAM), non-volatile memory (e.g., disk drives) and/or a combination thereof. The processor 202 cooperates with support circuitry 206, such as power supplies, clock circuits, cache memory, among other conventional support circuitry, to assist in executing software routines (e.g., method 300) stored in the memory 210. The one or more processors 202, memory 210 and support circuitry 206 are all commonly connected to each other through one or more bus and/or communication mediums (e.g., cabling) 208.

The server 200 also comprises input/output (I/O) circuitry 204 that forms an interface between various functional elements communicating with the server 200. For example, the server 200 is connected to a communication link through an I/O interface 204, which receives information from and sends information over the communication link to the processing facilitator 108.

The memory 210 includes program storage 212 and data storage 220. The program storage 212 stores an address verification program or module 214 capable of performing various routines, such as method 300 (FIG. 3) of the present invention. The program storage 212 also stores an operating system (not shown), such as a WINDOWS®, UNIX®, or SQL® operating system, among other application program modules as required.

The data storage 220 can be an internal or separate storage device, such as one or more disk drive arrays that can be accessed via the I/O interface 204 to read/write data. The data storage 220 can store the card information provided from the issuer 102, temporal indicators associated with time periods since a cardholder of a financial presentation device last change the billing statement address in accordance with the present invention, among other information. Any of the software program modules in the program storage 212 and data from the data storage 214 are transferred to the memory 210 as needed for execution by the processor 202.

As such, it is contemplated that some of the process steps discussed herein as software processes may be implemented within hardware, for example, as circuitry that cooperates with the processor 202 to perform various steps. It is noted that the operating system (not shown) and optionally various application programs (not shown) are stored in the memory 210 to run specific tasks and enable user interaction.

Referring to the flow diagram of FIG. 3, method 300 is a program routine for providing an address verification response to a merchant 106 conducting a transaction with a cardholder 110. In accordance with the present invention, the address verification response includes an indicator representing a time period since a cardholder 110 of a financial presentation device 112 has last changed an address of record with an issuer of the financial presentation device. The merchant 106 can use the address verification response to assist in deciding whether to accept, further investigate, or decline, for example, a card-not-present transaction with the cardholder 110.

The address verification requests can be processed in real-time by the issuer 102. Real time requests typically are used for transactions occurring at the website of the merchant, during which the customer waits on-line for a response.

The method 300 starts at 301, where a cardholding customer 110 and merchant 106 engage in a sales transaction for goods and/or services. The sales transaction can be a card present transaction where the card can be swiped through a magnetic strip reader or is key entered into a card terminal at the point of sale, that is, at the merchant's physical location. Alternatively, the point-of-sale can be a card-not-present transaction being conducted at a virtual location of the merchant, such as at a website of the merchant 106, by telephone, or by mail. In either case, a request for verification and authorization of the transaction is sent by the merchant 106 to the issuer 102 of the cardholder during execution of the transaction.

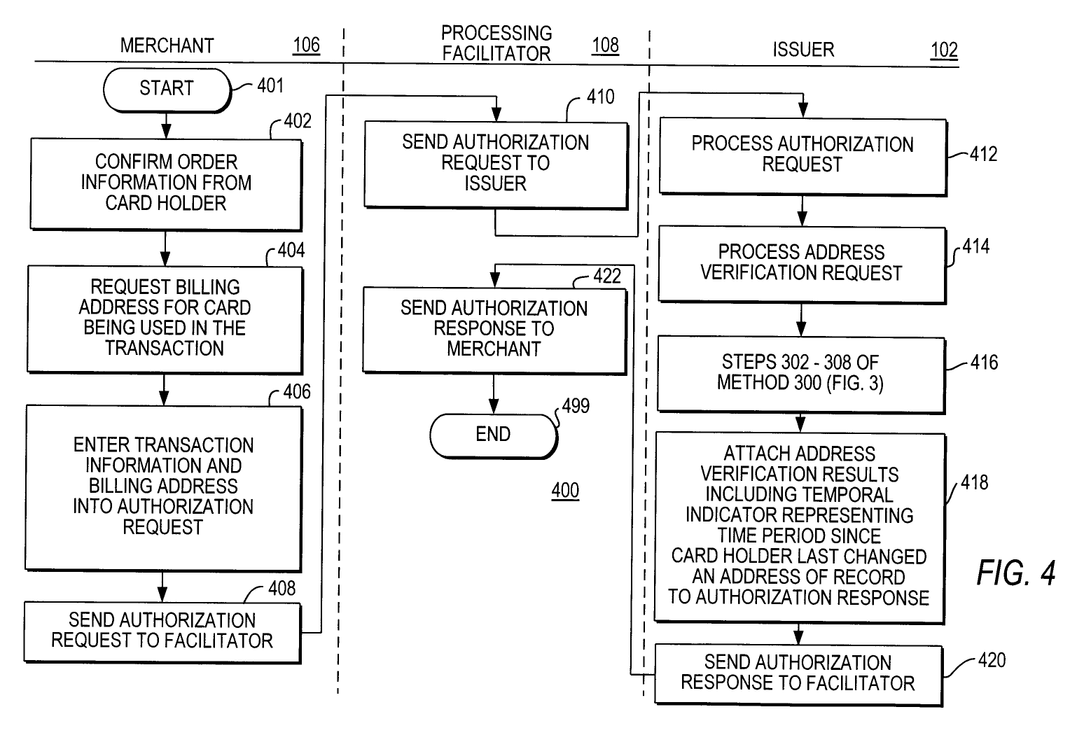

The merchant 106 can request the address verification either by itself (method 300 of FIG. 3), or as part of a transaction authorization request, as described in further detail with respect to method 400 of FIG. 4. The merchant 106 can send the address verification request without an accompanying authorization request if, for example, the merchant wants to verify the customer's billing address before an authorization request is made; or if a response from a previous sent address verification request was unattainable.

At step 302, the issuer 102 (or processing facilitator 108) receives an address verification request to verify an address associated with the financial presentation device 112. For card-present transactions, the verification request is sent electronically by the merchant 106 from either their card terminal or by telephone to the issuer 102 via the merchant's acquirer 104 and the processing facilitator 108 in a well known manner. For card-not present transactions, the customer provides their account identifier, expiration date and latest address (e.g., billing statement address) information at the virtual point-of-sale location.

In particular, to request address verification in a card-not-present situation, the merchant must request the cardholder to provide a current address, such as the current billing statement address. For example, the merchant's website on the internet can provide a form or link on a webpage that requests and permits the customer to enter at least his/her account number, expiration date and latest billing statement address. Upon completing the account identifier and address information in the form, the customer 110 sends the completed information to the merchant 106 by clicking on a “send” button or other well-known descriptive icon to transmit the address information over the internet to the server domain of the merchant 106. The merchant 106 then sends the information electronically to the issuer 102, either directly or through the acquirer 104 and processing facilitator 108 in a similar manner as described above regarding card-present transaction. Where the card-not-present transaction is being conducted by telephone, then a representative of the merchant 106 will orally receive the account identifier and billing statement address information over the telephone and forward the received information electronically to the issuer 102 for verification and authorization.

Once the merchant has received the cardholder profile information (i.e., account identifier and latest address), the address verification request can be prepared by the merchant 106 and sent to the issuer 102 electronically or by telephone. In a preferred embodiment, the address information of the cardholder is entered into the terminal at the merchant's location and sent to the issuer 102 electronically over the internet (e.g., T1 connection), telephone lines, among other well-known mediums for transferring electronic information.

At step 304, the issuer 102 receives the address verification request to verify an address associated with the financial presentation device, and retrieves profile information associated with the cardholder of the present request. Referring to FIG. 2, the computer device 200 of the issuer 102 includes a database of profile information for all of its credit card holders. The profile information includes the full name, latest billing address, one or more shipping addresses, and authentication information, among other profile information of each cardholder to whom a credit card 112 has been issued by the issuer 102. The cardholder profile information also includes information pertaining to a time period since the cardholder last changed the billing statement address of record with the issuer.

In particular, the issuer 102 stores in one or more databases, all of the cardholder identifying information for each issued financial presentation device, including the account identifier (e.g., account number), expiration date, cardholder name, security-code information, billing statement address, date billing statement address, among other identifying, security and administrative information.

At step 306, a time period since the cardholder last change an address (e.g., the billing statement address) is determined. In one embodiment, the issuer 102 tracks and stores the time period since the cardholder 110 last changed an address of record, such as the billing statement address or shipping address for the financial presentation device 112. Alternatively, the issuer stores the date (i.e., date of record) that an address change last occurred and calculates the time period, for example, the number of days since a last address change has elapsed from the current date. Once the time period is determined, it can be stored in the profile database associated with the cardholder.

At step 308, the issuer 102 determines a temporal indicator identifying a time period since a cardholder of the financial presentation device last changed the billing statement address. The determination of a temporal indicator can include determining which one of the plurality of time ranges the calculated time period belongs.

In one embodiment, an alpha-numeric character can be designated to represent a range of time periods, such as a number of days since the address last changed. For example, a “0” can be used to represent no information available; “1” represents 5 days or less; “2” represents 6-30 days; “3” represents 31-60 days; “4” represents 61-90 days; “5” represents 91-120 days; “6” represents 121-180 days; “7” represents 181-365 days and “8” represents greater than 365 days. A person skilled in the art for which the invention pertains to will appreciate that other alpha-numeric characters or indicators can be used to represent the time period ranges. Alternatively, the actual number of days since the address last changed can be provided to the merchant.

At step 310, the address verification program 214 is operable to provide the temporal indicator corresponding to the time period or one of a range of time periods to the merchant. In one embodiment, the temporal indicator is included with other address verification information provided by the issuer in the response. For example, the issuer can provide an additional indicator that signifies whether the latest address given by the cardholder is an exact match, partial match, or not a match with the address (e.g., billing statement address) of record. In one embodiment, a letter “Y” signifies an exact match of the street address and the zip code; “A” signifies a partial match, where the street address matches but the zip code does not match; “Z” signifies a partial match, where the zip code matches but the street address does not match; “N” signifies no match of street address and the zip code; and “G” signifies address information is unavailable.

In an embodiment where the merchant has large sales volumes which warrant a direct electronic connection to the processing facilitator 108, the issuer 102 sends the address verification response to the processing facilitator 108, which forwards the response directly to the merchant 106. In an embodiment where the merchant 106 has an electronic connection with the acquirer 104, the issuer 102 sends the response to the processing facilitator 108, which forwards the response to the acquirer 104, which in turn forwards the response to the merchant 106. Alternatively, where the merchant has a small or infrequent number of transactions, or when transactions are key entered, the merchant 106 can access a toll-free telephone number provided by the processing facilitator 108 to receive the address verification response. In any embodiment, the address verification service, which includes the indicator representing a time period since the cardholder last changed an address of record, helps reduce the risk of accepting fraudulent transactions by facilitating verification of the cardholder's billing address with the card issuer. The merchant 106 can then make a more informed decision whether to accept a particular transaction with a cardholder 110.

FIG. 4 is a flow diagram of another embodiment of a method 400 for providing an address verification response to a merchant conducting a transaction with a cardholder in accordance with the present invention. As noted above, an address verification request from a merchant 106 can be sent along with a request to authorize a transaction with the cardholder 110. The authorizing of a credit card transaction verifies that the customer's (i.e., cardholder's) account is valid and that sufficient funds are available to cover the transaction's cost. At this step, the funds are “held” and deducted from the customer's credit limit (or bank balance, in the case of a debit card) but are not yet transferred to the merchant.

A merchant 106 can process an address verification request in a similar manner as transaction authorization requests are processed, i.e., on a real-time basis using an electronic terminal or personal computer. The method 400 starts at step 401, where a customer engages with a merchant 106 to place an order for goods and/or services. At step 402, for card-not present purchases, the merchant confirms the order information including the merchandise description, price, the credit card identifier number, card expiration date, and shipping address.

At step 404, the merchant requests the cardholder to also provide address information associated with the card being used for the transaction. Preferably, the merchant requests that the cardholder provide the latest billing statement address, although other the latest shipping address can be requested in lieu of or in addition to the billing statement address. The method 400 then proceeds to step 406, where the transaction information, including the billing statement address information is included (i.e., entered) with the authorization request. At step 408, the authorization request is sent to the processing facilitator 108.

At step 410, the processing facilitator 108 forwards the authorization request to the issuer 102. As noted above, the merchant can either send the authorization request directly to the processing facilitator 108 or to the acquirer 104, which subsequently forwards the authorization request to the processing facilitator.

At step 412, the issuer 102 receives and processes the authorization request. In particular, the address verification information (i.e., request) is parsed from the authorization request and processed separately therefrom. At step 414, the issuer 102 processes the address verification request. In particular, at step 416, steps 302 to 308 of method 300 are performed, as discussed above with respect to FIG. 3. Once the temporal indicator representing the time period since the cardholder last changed an address (e.g., billing statement address) associated with the card 112 being used during the transaction has been determined, the method 400 proceeds to step 418.

At step 418, the address verification results, which include the temporal indicator, as well as whether the address provided by the cardholder is an exact match, partial match, or not a match, is included with the transaction authorization response message. At step 420, the authorization response message is sent to the processing facilitator 108, where at step 422, the processing facilitator 108 forwards the authorization response message to the merchant 106 either directly or through the acquirer 104. The method 400 then proceeds to step 499, where the method 400 ends.

The present invention helps merchants, and especially CNP merchants utilizing the address verification system (AVS) to identify possible account takeover transactions. Besides providing a result code pertaining to whether the customer provided billing address is an exact, partial or not a match with the address of record of the issuer, the issuers can also provide the an indicator representing the number of days since a cardholder last changed their billing statement address. CNP merchants can use this incremental AVS data element, to make a more informed transaction decision (e.g., approve, decline, investigate).

From the perspective of the merchants 106, the address verification system (AVS) of the present invention advantageously reduces the risks associated with “chargebacks,” which often occur when a bonafide cardholder disputes a charge on their monthly statement. In particular, a chargebacks typically occurs when the cardholder 110 disputes a transaction appearing on the billing statement and contacts the card issuer 102 for resolution. If the issuer 102 is not able to resolve the disputed item, the issuer 102 will charge it back to the merchant processor (i.e., acquirer) 104 for the costs of the transaction. This means that the dollar value (i.e., the financial liability) for the transaction is charged back to the acquirer 104 and, usually, by the acquirer 104 to the merchant 106, which results in the merchant 106 losing the fraudulently purchased item (or time associated with services), as well as the revenues generated by the sale. The present invention enables merchants 106 to more readily detect and prevent fraudulent transaction activities, and accordingly reduce the number of chargebacks and the administrative and revenue costs associated therewith.

From the perspective of the issuers 102 and acquirers 104, the AVS of the present invention also advantageously reduces the administrative costs associated with charge backs to the acquirers 104 (and ultimately the merchants 106) for fraudulent purchase transactions. From the perspective of the consumer 110, the AVS of the present invention can help reduce the time spent with the issuer 102 to dispute a fraudulent transaction.

The foregoing specific embodiments represent just some of the ways of practicing the present invention. Many other embodiments are possible within the spirit of the invention. Accordingly, the scope of the invention is not limited to the foregoing specification, but instead is given by the appended claims along with their full range of equivalents.

What is claimed is:

1. A method for providing data for use in reducing fraudulent transactions between a holder of a financial presentation device and a merchant, the method comprising:
receiving from a merchant an address verification request to verify an address associated with the financial presentation device;
determining a temporal indicator identifying a time period since the holder of the financial presentation device last changed the address in response to the received address verification request; and
providing the determined temporal indicator to the merchant.

2. The method according to claim 1, wherein the step of receiving an address verification request includes receiving a billing address associated with the financial presentation device, further comprising sending to the merchant an indication of whether the received billing address matches the billing address of the holder of the financial transaction device.

3. The method according to claim 1, wherein the step of determining a temporal indicator includes:
retrieving a date associated with the last address change; and
calculating the time period from a current date of the request to the retrieved date associated with the last address change.

4. The method according to claim 3, wherein the time period since the holder of the financial presentation device last changed the address is divided into a plurality of time ranges, wherein:
the step of determining a temporal indicator includes determining which one of the plurality of time ranges the calculated time period belongs; and
the step of providing the determined temporal indicator includes sending the determined time range to the merchant.

5. The method according to claim 1, wherein the step of providing the determined temporal indicator includes providing a number of days since the occurrence of the most recent change of address.

6. The method according to claim 1, wherein the step of providing the determined temporal indicator includes providing one or more alpha-numeric characters representing a range of time periods since the holder of the financial presentation device last changed the address or no information available.

7. The method according to claim 6, wherein the step of providing one or more alpha-numeric characters includes providing at least one first alpha-numeric character representing no information available, at least one second alpha-numeric character representing less than five days, at least one third alpha-numeric character representing 5 to 30 days, at least one fourth alpha-numeric character representing 30 to 60 days, at least one fifth alpha-numeric character representing 61 to 90 days, at least one sixth alpha-numeric character representing 91 to 120 days, at least one seventh alpha-numeric character representing 121 to 180 days, at least one eighth alpha-numeric character representing 181 to 365 days, and at least one ninth alpha-numeric character representing greater than 365 days.

8. The method according to claim 1, wherein the step of receiving an address verification request comprises receiving a request originating from a card-not-present merchant.

9. The method according to claim 1, wherein the step of receiving an address verification request further comprises receiving a request to authorize the transaction.

10. The method according to claim 9, wherein the step of providing the determined temporal indicator further comprises providing the temporal indicator in a predetermined field of a response to the authorization message.

11. A system for providing an address verification response associated with a financial presentation device being used to conduct a transaction with a merchant, the system comprising:
a memory storing addresses of holders of financial presentation devices and a date corresponding to a last change of address associated with each financial presentation device;
a processor coupled to the memory; and
an address verification program stored in the memory and executable by the processor, the address verification program operable to:
receive a request from the merchant to verify an address associated with the financial presentation device;
determine a temporal indicator identifying a time period since a holder of the financial presentation device last changed the address; and
provide the determined temporal indicator with the address verification response to the merchant.

12. The system according to claim 11, wherein:
the address is a billing address associated with the financial presentation device; and
the address verification program is further operable to send the merchant an indication of whether the received billing address matches the billing address of the holder of the financial transaction device.

13. The system according to claim 11, wherein the address verification program is further operable to:
retrieve a date associated with the last address change; and
calculate the time period from a current date of the request to the retrieved date associated with the last address change.

14. The system according to claim 13, wherein the time period since the holder of the financial presentation device last changed the address is divided into a plurality of time ranges, and wherein the address verification program is operable to:
determine which one of the plurality of time ranges the calculated time period belongs; and
send the determined time range to the merchant.

15. The system according to claim 11, wherein the temporal indicator includes a number of days since the occurrence of the most recent change of address.

16. The system according to claim 11, wherein the temporal indicator comprises one or more alpha-numeric characters representing a range of time periods since the holder of the financial presentation device last changed the address or that no information is available.

17. The system according to claim 11, wherein the address verification program receives the request to verify an address from a card-not-present merchant.

18. The system according to claim 11, wherein the address verification program is operable to receive a request to authorize the transaction.

19. The system according to claim 18, wherein the address verification program is operable to provide the temporal indicator in a predetermined field of a response to the transaction authorization message.
